(19) United States
(12) Patent Application Publication
(10) Pub. No.: US 2026/0042423 A1
(43) Pub. Date: Feb. 12, 2026

(54) TRANSPARENT WINDSHIELD WIPER DEVICE

(71) Applicant: Alfred Harkness, Sanford, FL (US)

(72) Inventor: Alfred Harkness, Sanford, FL (US)

(21) Appl. No.: 19/054,971

(22) Filed: Feb. 17, 2025

Related U.S. Application Data
(60) Provisional application No. 63/556,923, filed on Feb. 23, 2024.

(51) Int. Cl. B60S 1/38

(52) U.S. Cl. CPC B60S 1/38; B60S 2001/3829

(57) ABSTRACT

The present invention relates to a transparent windshield wiper device. The device is primarily comprised of a frame with at least one clip, at least one bushing, at least one secondary clip, at least one blade, and at least one adaptor. In the preferred embodiment, all components of the device are transparent. This prevents the device from obstructing the view of the user while being used to clean a vehicle windshield.

### CROSS-REFERENCE TO RELATED APPLICATION

The present application claims priority to, and the benefit of, U.S. Provisional Application No. 63/556,923, which was filed on Feb. 23, 2024, and is incorporated herein by reference in its entirety.

### FIELD OF THE INVENTION

The present invention relates generally to the field of vehicle windshield wipers. More specifically, the present invention relates to a transparent windshield wiper device. The components of the device are transparent, such that they do not obstruct the view of the user while being used to clean a vehicle windshield. Accordingly, the present disclosure makes specific reference thereto. Nonetheless, it is to be appreciated that aspects of the present invention are also equally applicable to other like applications, devices, and methods of manufacture.

### BACKGROUND

Vehicle owners may struggle to see properly out of their windshield while using their windshield wipers. Furthermore, heavy precipitation or fog may increase the difficulty of viewing a roadway when windshield wipers are being used. Difficulty viewing a roadway while driving can be dangerous and cause accidents.

Therefore, there exists a long-felt need in the art for an improved windshield wiper. More specifically, there exists a long-felt need in the art for a transparent windshield wiper device. In addition, there exists a long-felt need in the art for a transparent windshield wiper device that does not obstruct the view from the windshield of a vehicle during use.

The subject matter disclosed and claimed herein, in one embodiment thereof, comprises a transparent windshield wiper device. The device is primarily comprised of a frame with at least one clip, at least one bushing, at least one secondary clip, at least one blade, and at least one adaptor. In the preferred embodiment, all components of the device are transparent. This prevents the device from obstructing the view of the user while being used to clean a vehicle windshield.

In this manner, the transparent windshield wiper device of the present invention accomplishes all the foregoing objectives and provides an improved windshield wiper. More specifically, the device provides a windshield wiper that does not obstruct the view from the windshield of a vehicle during use.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a transparent windshield wiper device. The device is primarily comprised of a frame with at least one clip, at least one bushing, at least one secondary clip, at least one blade, and at least one adaptor. The adaptor preferably attaches to the frame via at least one fastener. The adaptor allows the device to attach to the windshield wiper stock of a vehicle.

The frame provides structural support to the device and is preferably comprised of at least one clip. The clip may be any style of clip known in the art that allows the frame to be removably attached to the wiper blade. More specially, the clip preferably attaches to at least one groove on the blade. The frame may also be comprised of at least one secondary clip that further attaches to the groove of the blade. The secondary clip preferably attaches to the frame via at least one bushing that prevents the clip from rubbing against the frame during motion of the device.

The clip, bushing, and frame may attach via at least one fastener placed through at least one opening of the clip, at least one opening of the bushing, and at least one opening of the frame. The fastener preferably allows the secondary clip to flex and pivot in relation to the frame to allow the device to easily travel over a curved vehicle windshield without incurring significant stress that would otherwise snap the frame without the secondary clip.

The frame, clips, bushing, secondary clip, flexor, adaptor, and fasteners are all preferably made from a transparent material. More specifically, said components are preferably made from a rigid, transparent plastic material that is UV-resistant. In this manner, said components do not obstruct the user's view of the road during use, especially during inclement weather. The blade is also preferably made from a transparent rubber material such as but not limited to natural rubber, silicone, etc. In this manner, the blade does not obstruct the user's view of the road during use, especially during inclement weather.

The present invention is also comprised of a method of using the device. First, a device is provided, the device is comprised of a transparent frame with at least one transparent clip, at least one transparent bushing, at least one transparent secondary clip, at least one transparent blade, and at least one transparent adaptor. Said components may also have a coating that is comprised of a phosphorescent, chemiluminescent, or fluorescent coating. Then, the device is attached to a wiper stock of a vehicle via the adaptor. Then, the device can be used to clear precipitation from a windshield of the vehicle.

Accordingly, the transparent windshield wiper device of the present invention is particularly advantageous as it provides an improved windshield wiper. More specifically, the device provides a windshield wiper that does not obstruct the view from the windshield of a vehicle during use. In this manner, the transparent windshield wiper device overcomes the limitations of existing windshield wipers known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an exploded view of one potential embodiment of a transparent windshield wiper device of the present invention in accordance with the disclosed architecture; and

FIG. 2 illustrates a flowchart of a method of using one potential embodiment of a transparent windshield wiper device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved windshield wiper. More specifically, there exists a long-felt need in the art for a transparent windshield wiper device. In addition, there exists a long-felt need in the art for a transparent windshield wiper device that does not obstruct view from the windshield of a vehicle during use.

The present invention, in one exemplary embodiment, is comprised of a transparent windshield wiper device primarily comprised of a frame with at least one clip, at least one bushing, at least one secondary clip, at least one blade, and at least one adaptor. The adaptor preferably attaches to the frame via at least one fastener and allows the device to attach to the windshield wiper stock of a vehicle. The frame provides structural support to the device and is preferably comprised of at least one clip that allows the frame to be removably attached to the wiper blade. More specifically, the clip preferably attaches to at least one groove on the blade. The frame may also be comprised of at least one secondary clip that further attaches to the groove of the blade. The secondary clip preferably attaches to the frame via at least one bushing that prevents the clip from rubbing against the frame during motion of the device.

The clip, bushing, and frame may attach via at least one fastener placed through at least one opening of the clip, at least one opening of the bushing, and at least one opening of the frame. The fastener preferably allows the secondary clip to flex and pivot in relation to the frame. This allows the device to easily travel over a curved vehicle windshield without incurring significant stress that would otherwise snap the frame without the secondary clip.

The frame, clips, bushing, secondary clip, flexor, adaptor, and fasteners are all preferably made from a transparent material. More specifically, said components are preferably made from a rigid, transparent plastic material that is UV-resistant. In this manner, said components do not obstruct the user's view of the road during use, especially during inclement weather. The blade is also preferably made from a transparent rubber material such as, but not limited to, natural rubber, silicone, etc. In this manner, the blade does not obstruct the user's view of the road during use, especially during inclement weather.

The present invention is also comprised of a method of using the device. First, a device is provided, the device is comprised of a transparent frame with at least one transparent clip, at least one transparent bushing, at least one transparent secondary clip, at least one transparent blade, and at least one transparent adaptor. Said components may also have a coating that is comprised of a phosphorescent, chemiluminescent, or fluorescent coating. Then, the device is attached to a wiper stock of a vehicle via the adaptor. Then, the device can be used to clear precipitation from a windshield of the vehicle.

Accordingly, the transparent windshield wiper device of the present invention is particularly advantageous as it provides an improved windshield wiper. More specifically, the device provides a windshield wiper that does not obstruct the view from the windshield of a vehicle during use. In this manner, the transparent windshield wiper device overcomes the limitations of existing windshield wipers known in the art.

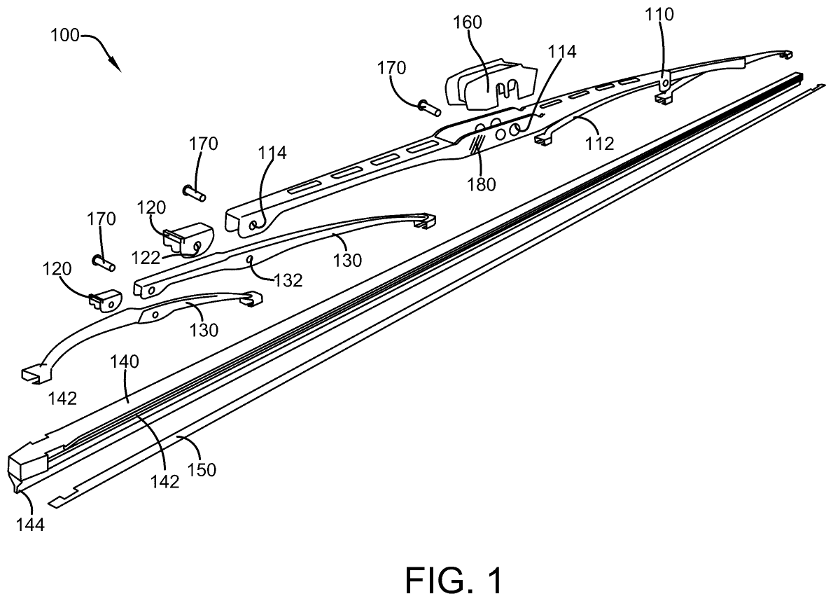

Referring initially to the drawings, FIG. 1 illustrates an exploded view of one potential embodiment of a transparent windshield wiper device 100 of the present invention in accordance with the disclosed architecture. The device 100 is primarily comprised of a frame 110 with at least one clip 112, at least one bushing 120, at least one secondary clip 130, at least one blade 140, and at least one adaptor 160. The adaptor 160 preferably attaches to the frame 110 via at least one fastener 170. The fastener 170 may be a rivet or other fastener of the like. The adaptor 160 allows the device 100 to attach to the windshield wiper stock of a vehicle. The adaptor 160 is preferably any adaptor style known in the art of windshield wipers that allows the device 100 to attach to a vehicle such as, but not limited to, a J-hook adaptor, a side pin adaptor, a bayonet adapter, a U-hook adaptor, a side lock adaptor, a top lock adaptor, a pinch tab adaptor, a slim top adaptor, etc.

The frame 110 provides structural support to device 100. The frame 110 may be comprised of at least one clip 112. The clip 112 may be fixedly attached to the frame 110 or removably attached via at least one fastener 170. The clip 112 may be any style of clip known in the art that allows the frame 110 to be removably attached to the wiper blade 140. More specifically, the clip 112 preferably attaches to at least one groove 142 on the blade 140.

The frame 110 may also be comprised of at least one secondary clip 130. The secondary clip 130 further attaches to the groove 142 of the blade 140. The secondary clip 130 preferably attaches to the frame 110 via at least one bushing 120 that prevents the clip 130 from rubbing against the frame 110 during motion of the device 100.

The clip 130, bushing 120, and frame 110 may attach via at least one fastener 170. The fastener 170 is placed through at least one opening of the clip 132, at least one opening of the bushing 122, and at least one opening 114 of the frame 110. The fastener 170 preferable allows the secondary clip 130 to flex and pivot in relation to the frame 110. This allows the device 100 to easily travel over a curved vehicle windshield without incurring significant stress that would otherwise snap the frame 110 without the secondary clip 130.

The blade 140 may be any shape known in the art but is preferably generally rectangular with a triangular bottom edge 144 to allow the blade 140 to easily glide over a windshield while removing debris and precipitation. The blade 140 is preferably flexible to conform to a curved vehicle windshield during use. The blade 140 may receive at least one flexor 150. The flexor 150 is made from a rigid, flexible material that supports the blade 140 and ensures consistent distribution of wiping pressure during use.

The frame 110, clips 112, bushing 120, secondary clip 130, flexor 150, adaptor 160, and fasteners 170 are all preferably made from a transparent material. More specifically, said components are preferably made from a rigid, transparent plastic material that is UV-resistant such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. In this manner, said components do not obstruct the user's view of the road during use, especially during inclement weather. In addition, said components may have a coating 180. The coating 180 may be a phosphorescent, chemiluminescent, fluorescent, etc., which helps improve visual acuity.

The blade 140 is preferably made from a transparent rubber material such as, but not limited to, natural rubber, silicone, etc. In this manner, the blade 140 does not obstruct the user's view of the road during use, especially during inclement weather. In addition, said components may have a coating 180. The coating 180 may be a phosphorescent, chemiluminescent, fluorescent, etc., that helps improve visual acuity.

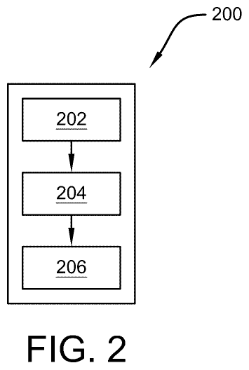

FIG. 2 illustrates a flowchart of a method 200 of using one potential embodiment of a transparent windshield wiper device 100 of the present invention in accordance with the disclosed architecture. The present invention is also comprised of a method 200 of using the device 100. First, a device 100 is provided, the device 100 is comprised of a transparent frame 110 with at least one transparent clip 112, at least one transparent bushing 120, at least one transparent secondary clip 130, at least one transparent blade 140, and at least one transparent adaptor 160 [Step 202]. Said components may also have a coating 180 that is comprised of a phosphorescent, chemiluminescent, or fluorescent coating. Then, the device 100 is attached to a wiper stock of a vehicle via the adaptor 160 [Step 204]. Then, the device 100 can be used to clear precipitation from a windshield of the vehicle [Step 206].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “transparent windshield wiper device” and “device” are interchangeable and refer to the transparent windshield wiper device 100 of the present invention.

Notwithstanding the foregoing, the transparent windshield wiper device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the transparent windshield wiper device 100 as shown in the FIGS. are for illustrative purposes only, and that many other sizes and shapes of the transparent windshield wiper device 100 are well within the scope of the present disclosure. Although the dimensions of the transparent windshield wiper device 100 are important design parameters for user convenience, the transparent windshield wiper device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A transparent windshield wiper device comprising:
a transparent frame comprised of a first opening and a transparent clip;
a transparent bushing comprised of a second opening;
a transparent secondary clip comprised of a third opening;
a transparent blade comprised of a groove and a bottom edge;
a transparent flexor;
a transparent adaptor; and
a transparent fastener.

2. The transparent windshield wiper device of claim 1, wherein the transparent adaptor is comprised of a J-hook adaptor, a side pin adaptor, a bayonet adapter, a U-hook adaptor, a side lock adaptor, a top lock adaptor, a pinch tab adaptor, or a slim top adaptor.

3. The transparent windshield wiper device of claim 1, wherein the bottom edge is comprised of a triangular bottom edge.

4. The transparent windshield wiper device of claim 1, wherein the transparent fastener is comprised of a rivet.

5. The transparent windshield wiper device of claim 1, wherein the transparent blade is comprised of a flexible rubber.

6. The transparent windshield wiper device of claim 1, wherein the transparent flexor is positioned in the groove of the transparent blade.

7. The transparent windshield wiper device of claim 1, wherein the transparent frame is comprised of a UV-resistant plastic.

8. The transparent windshield wiper device of claim 1, wherein the transparent bushing is comprised of a UV-resistant plastic.

9. The transparent windshield wiper device of claim 1, wherein the transparent secondary clip is comprised of a UV-resistant plastic.

10. The transparent windshield wiper device of claim 1, wherein the transparent frame is comprised of a UV-resistant plastic.

11. The transparent windshield wiper device of claim 1, wherein the transparent flexor is comprised of a UV-resistant plastic.

12. The transparent windshield wiper device of claim 1, wherein the transparent adaptor is comprised of a UV-resistant plastic.

13. The transparent windshield wiper device of claim 1, wherein the transparent fastener is comprised of a UV-resistant plastic.

14. A transparent windshield wiper device comprising:
a transparent frame comprised of a first opening and a transparent clip;
a transparent bushing comprised of a second opening;
a transparent secondary clip comprised of a third opening;
a transparent blade comprised of a groove and a bottom edge;
a transparent flexor;
a transparent adaptor;
a transparent fastener; and
a coating.

15. The transparent windshield wiper device of claim 14, wherein the coating is comprised of a phosphorescent coating, a chemiluminescent coating, or a fluorescent coating.

16. The transparent windshield wiper device of claim 15, wherein the transparent frame and the transparent clip are comprised of the coating.

17. The transparent windshield wiper device of claim 15, wherein the transparent blade is comprised of the coating.

18. The transparent windshield wiper device of claim 15, wherein the transparent secondary clip is comprised of the coating.

19. The transparent windshield wiper device of claim 15, wherein the transparent fastener is comprised of the coating.

20. A method of using a transparent windshield wiper device, the method comprising the steps of:
providing a transparent windshield wiper device comprised of a transparent frame comprised of a transparent clip, a transparent bushing, a transparent secondary clip, a transparent blade, and a transparent adaptor;
attaching the transparent windshield wiper device to a wiper stock of a vehicle via the transparent adaptor; and
using the transparent windshield wiper device to clear precipitation from a windshield of the vehicle.
